(19) United States
(12) Patent Application Publication
(10) Pub. No.: US 2006/0175569 A1
(43) Pub. Date: Aug. 10, 2006

(54) Automatic lock for ball valve

(76) Inventor: Terry Henson, Sadorus, IL (US)

Correspondence Address: Michael Berns;Maloney Parkinson & Berns, 135 West Main Street, Urbana, IL, 61801, US

(21) Appl. No.: 11/346,935

(22) Filed: Feb. 3, 2006

Related U.S. Application Data
(60) Provisional application No. 60/593,670, filed on Feb. 3, 2005.

(51) Int. Cl. F16K 51/00

(52) U.S. Cl. 251/287

(57) ABSTRACT

A locking a handle for a liquid valve, such that a latch must be operated to operate the handle. The latch is pressed against the handle by a spring, preventing operation of the handle, without the user rotating the latch.

### CROSS-REFERENCE TO RELATED APPLICATION

This application claims the benefit of U.S. Provisional Application 60/593,670, filed Feb. 3, 2005, which is incorporated herein by reference.

### BACKGROUND OF THE INVENTION

The invention relates to a ball valve. Ball valves are used on many liquid lines to reduce or shut off the flow. The valves are commonly used in plumbing and mechanical systems.

A variety of products have been developed to padlock a valve in an open or closed position, but there has been no success in providing an easy means of preventing accidental rotation of the valve. In many situations, accidentally shutting off, or turning on, the flow would have negative impacts. If the water line to a house was accidentally shut off, the water heater may be damaged. Accidentally turning on a water line valve may cause problems during construction or repairs. Water valves on a concrete truck may be accidentally turned on by hoses used on the truck. When excess water is added to the concrete, the entire load is ruined, causing thousands of dollars in damage. Frequent accidental operation of the valves would hurt the reputation of the driver, and the concrete supplier. Other situations arise, where the accidental operation of the valve would damage, or danger.

It is an object of this invention to provide an inexpensive, reliable manner to prevent the accidental operation of a ball valve.

### SUMMARY OF THE INVENTION

This invention provides a locking mechanism on the handle of a ball valve that prevents the accidental operation of the valve. This mechanism can be installed to an existing ball valve, or if desired, the mechanism could be incorporated into the design for a new ball valve.

A latch is pressed by a spring into the ball valve handle to prevent operation of the ball valve handle, unless the user wants the ball valve handle rotated. By affirmatively pressing a latch mechanism, it makes it safer to ensure that the valve is not being operated accidentally.

### DESCRIPTION OF THE DRAWINGS

FIG. 1 is an oblique view of an embodiment of the invention attached to a ball valve.

FIG. 2 is an oblique view of an embodiment of the invention as an add-on, without a ball valve.

FIG. 3 is an exploded view of an embodiment of the invention without a ball valve.

FIG. 4 is a top view of an embodiment of the invention attached to a ball valve.

### DETAILED DESCRIPTION OF THE INVENTION

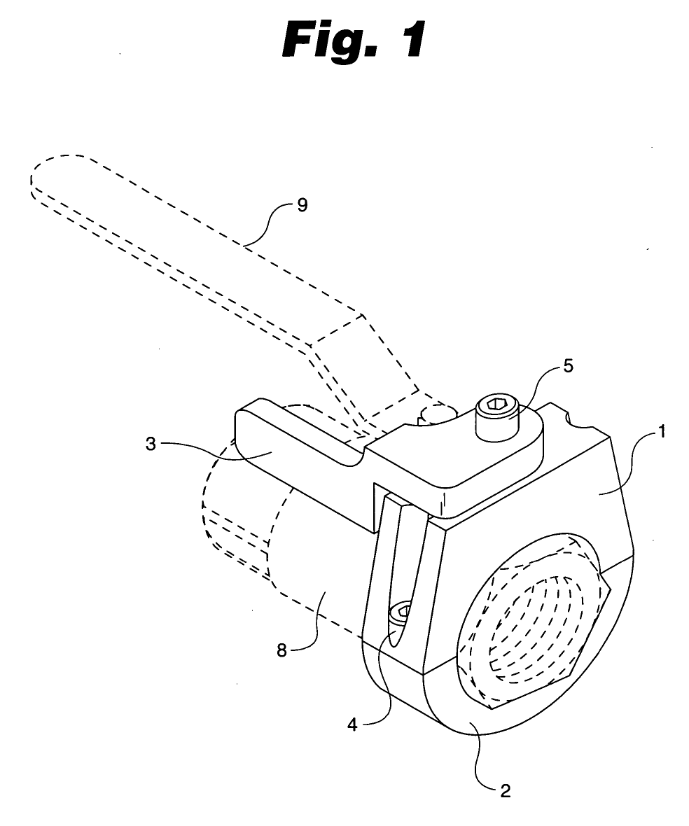

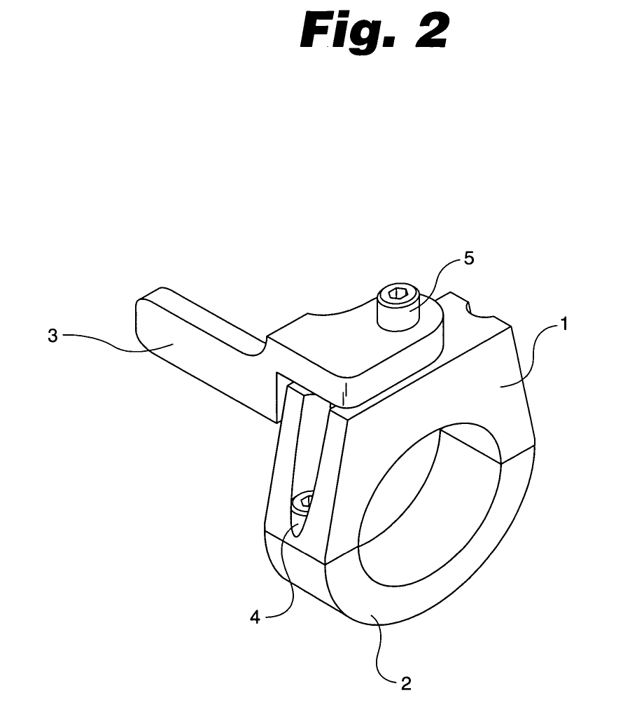

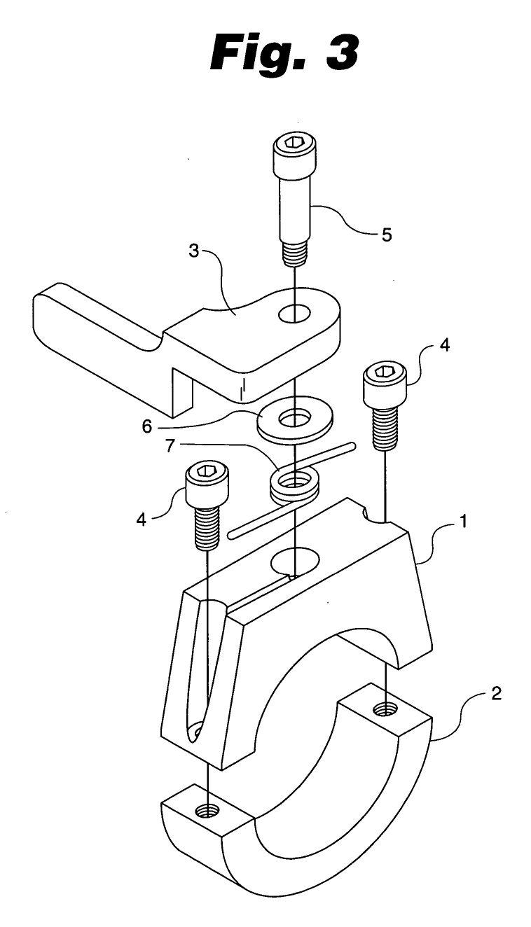

The preferred embodiment of the invention is for attachment to an existing ball valve. Construction of a ball valve with the features of the invention could easily be formed integrally with the valve. One example of the invention is shown in FIG. 2 and as an exploded view in FIG. 3. A main frame 1 is connected to the ball valve 8 by a locking bracket 2 and attachment bolts 4. A spring 7 is inserted into a slot in the frame 1, and inserted into a slot in a latch 3. A securing bolt 5 holds the latch 3 and spring 7 against the frame 1. A washer 6 may be used to ease motion of the latch 3. When installed in a ball valve, as shown in FIG. 1, the spring 7 pressures the latch 3 to rotate toward the ball valve handle 9.

On a typical ball valve 8, the ball valve handle 9 may be rotated from an open position, such that the ball valve handle 9 is in line with the longitudinal length of the ball valve 8, and the fluid supply line. In a closed position, the ball valve handle 9 is at an approximate 90 degree angle, transverse to the longitudinal length of the ball valve. The ball valve handle 9 incorporates an arm on the opposite side of the attachment to the ball valve 8, that limits rotation of the ball valve handle 9 to the open and closed positions.

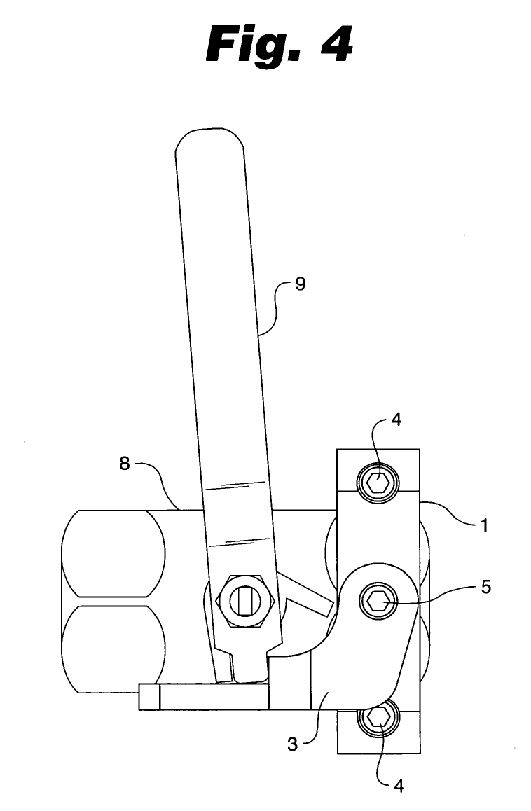

In operation of the invention, the arm that limits the rotation of the ball valve handle 9 is used to prevent operation of the ball valve handle 9 and ball valve 8. As shown in the top view FIG. 4, the ball valve handle is in a closed position, with the ball valve handle 9 in a position transverse to the ball valve 8 length. To close the valve, the ball valve handle 9 needs to be rotated counter-clockwise. Operation of the ball valve handle 9 is prevented from moving by the notch on the latch 3. To rotate the ball valve handle 9, the user must press the press the end of the latch 3 to rotate it counter-clockwise, until the depending tang, arm on the ball valve handle is clear of the notch on the latch 3 and rotation of the ball valve handle 9 may be accomplished.

The embodiment shown in the figures allows free operation of the ball valve handle 9 from the open position to the closed position, but requires movement of the latch 3 to open the valve. This makes it less likely to have difficulty in operating the valve to close the valve and have unwanted flow through the valve. Alternatively, the invention may operate to also require movement of the latch 3 to either open or close the valve, or just to close the valve. This could be accomplished by moving the position of the frame 1, and/or the shape of the latch 3.

By attaching the locking bracket 2 with the attachment bolts 4, the device as shown in the figures, may be attached to a ball valve 8 quickly and with only standard, readily available tools. An embodiment not shown would integrally form the frame 1 into the ball valve 8 or have the frame 1 constructed with the ball valve 8, such that the invention could operate as a unit. This would not have the ability to add the invention to existing ball valves and may not all for the removal of the unit, as needed.

Padlocks may optionally be attached, to prevent unauthorized operation of the ball valve. Holes could be provided through the latch 3 and the frame 1 to secure a padlock through both holes to prevent rotation of the latch 3, relative to the frame 1, such that the ball valve handle 9 could not be rotated. The padlock passing through both holes would register the latch 3 and frame 1 to prevent movement of the latch 3 and thus, movement of the valve handle 9.

It will be readily understood by those persons skilled in the art, that the present invention is susceptible to broad utility and application in changing light bulbs. Many embodiments and adaptations of the present invention, other than those described, as well as many variations, modifications, and equivalent arrangements, will be apparent from or reasonably suggested by the present invention and foregoing description thereof, without departing from the substance or scope of the invention.

While the foregoing description illustrates and describes exemplary embodiments of this invention, it is to be understood that the invention is not limited to the construction and design disclosed herein. The invention can be embodied in other specific forms without departing from the true invention.

What is claimed is:

1. A fluid valve comprising:
a valve body having a bore therein for flow of liquid,
un upstanding boss on said valve body,
a shaft journaled in said boss, said shaft being operatively coupled to a valve disposed in said body for controlling the flow of fluid through said bore,
a handle keyed on said shaft for rotating said shaft between valve open and valve closed positions, said handle being elongated having a depending tang at one end and a grasping portion at the other end,
a nut securing said handle to said shaft,
a first stop flange on said body for limiting rotatable movement of said shaft at a valve open position,
a second stop flange on said body for limiting rotatable movement of said shaft at a valve closed position,
said tang on said handle being disposed between said first stop flange and said second stop flange and rotatable with said handle into engagement with said first and second stop flanges,
a frame attached to said body,
a latch rotatably attached to said frame,
means for biasing the latch against said handle, such that said depending tang of said handle is prevented from rotating from said valve closed position to said valve open position by the latch, unless said latch is manually rotated, to allow rotation of said handle.

2. The fluid valve according to claim 1, further comprising holes in said frame and said latch for receipt of a lock device for selectively preventing rotation of said handle from the valve open and valve closed positions.

3. A fluid valve comprising:
a valve body,
a valve stem,
a handle secured to said valve stem,
a latch rotatably attached to said valve body,
means for biasing said latch against said handle to prevent rotation of said handle,
and means for rotating said latch to allow rotation of said handle.

4. The fluid valve according to claim 3, wherein said means for biasing said latch against said handle comprises a spring.

5. A fluid valve comprising:
a valve body,
a valve stem,
a handle secured to said valve stem,
said handle rotatable to a valve open position and a valve closed position,
said handle having a gripping end and a tang end,
a frame attached to said valve body,
a latch rotatably attached to said frame,
a spring for biasing said latch against said tang end of said handle, such that such handle may only rotate from said valve closed position to said valve open position when said latch is rotated away from said tang end.

6. A frame for attaching to a fluid valve having a handle for operating the valve from a valve open and a valve closed position, comprising:
an attachment bracket,
a frame,
means for attaching said attachment bracket to said frame,
a latch rotatably attached to said frame,
a spring for pressuring said latch against said handle of said fluid valve to prevent rotation of said handle from said closed position and said open position, unless a user rotates said latch.

7. A kit for adding a locking mechanism to a fluid valve comprising:
a frame,
means for attaching the frame to the fluid valve,
a latch rotatably attached to the frame,
means for biasing the latch against the handle to prevent operation of the handle, such that the latch may be rotated by the user to allow rotation of the handle.
